(19) United States
(12) Patent Application Publication
(10) Pub. No.: US 2026/0279302 A1
(43) Pub. Date: Sep. 17, 2026

(54) SOURCE DRIVER PERFORMING EYE MARGIN TEST FOR SIGNAL QUALITY VISUALIZATION AND OPERATING METHOD THEREOF

(71) Applicant: Samsung Electronics Co., Ltd., Suwon-si (KR)

(72) Inventors: Junho Park, Suwon-si (KR); Wonho Jang, Suwon-si (KR); Yong-yun Park, Suwon-si (KR); Kyungho Ryu, Suwon-si (KR); Jung-pil Lim, Suwon-si (KR); Hyunwook Lim, Suwon-si (KR); Junho Han, Suwon-si (KR)

(21) Appl. No.: 19/538,412

(22) Filed: Feb. 12, 2026

(30) Foreign Application Priority Data
Mar. 11, 2025 (KR) 10-2025-0031572
Aug. 13, 2025 (KR) 10-2025-0112403

(51) Int. Cl. G09G 3/36; G09G 3/20

(52) U.S. Cl. CPC G09G 3/3688; G09G 3/20; G09G 3/3648; G09G 3/3696; G09G 2310/08

(57) ABSTRACT

An example display device includes a display panel having a plurality of pixels and data lines, a timing controller for providing image data and an eye margin test signal, and a source driver for performing an eye margin test on the received data to generate and output data signals. The source driver generates eye margin test result data and corresponding data signals based on the test. Accordingly, the display device can visually verify interface signal integrity and optimize display driving characteristics in real time.

### CROSS-REFERENCE TO RELATED APPLICATIONS

This application claims priority to and the benefit of Korean Patent Application No. 10-2025-0031572 filed with the Korean Patent Office on Mar. 11, 2025, and Korean Patent Application No. 10-2025-0112403 filed with the Korean Patent Office on Aug. 13, 2025, the entire contents of which are incorporated herein by reference.

### BACKGROUND

Measurement of eye diagram margin is essential to ensure signal integrity in high-speed interface circuits. Although it is possible to detect errors due to eye margins inside the chip, it is difficult to directly check the status from the outside. Exposing the eye margin information externally requires adding separate test pads or pins, which increases chip area and design complexity. Additionally, it reduces efficiency in terms of real-time debugging and field testing.

### SUMMARY

The present disclosure relates to a display device and a method of operating the display device for visualizing eye diagram margin information inside a chip in real time without external resources.

In some embodiments, a display device comprises a display panel including a plurality of pixels and a plurality of data lines connected to the plurality of pixels, a timing controller configured to receive image data and output data generated based on the image data and an eye margin test signal that instructs testing of the eye margin, and a source driver connected to corresponding data lines among the plurality of data lines, and configured to receive first data corresponding to pixels connected to the data lines among the data from the timing controller and the eye margin test signal, perform the eye margin test on the first data to generate an eye margin test result data, generate a plurality of data signals corresponding to the eye margin test result data, and output the plurality of data signals to the data lines.

In some embodiments, a source driver comprises an interface circuit configured to generate equalization processing data by equalizing data, generate a normal data signal based on the equalization processing data, and generate eye margin test result data by sampling the equalization processing data at a reference timing interval based on the eye margin test signal at an enable level, and a display driving circuit configured to generate a data signal corresponding to the eye margin test result data.

In some embodiments, a method of driving a display device comprises receiving the eye margin test signal from a timing controller, the eye margin test signal instructing a test of data and eye margin, performing an eye margin test on the data to generate eye margin test result data, generating an eye diagram data signal including grayscale information for displaying an eye diagram based on the eye margin test results, and applying a data signal corresponding to the eye diagram signal to a plurality of pixels.

### BRIEF DESCRIPTION OF THE DRAWINGS

FIG. 1 is a block diagram of an example of a display device.

FIG. 2 is a block diagram of an example of a first source driver.

FIG. 3 is a block diagram illustrating an example of a first source driver.

FIG. 4 is a block diagram of an example of a timing controller and an example of a first source driver.

FIG. 5 is a block diagram illustrating an example of a timing controller and an example of a first source driver.

FIG. 6 is a timing diagram for example signals transmitted and received by a first source driver, a second source driver, and an n-th source driver to and from a timing controller.

FIG. 7 is a conceptual diagram illustrating an example of a process in which a second source driver outputs readback data.

FIG. 8 is a conceptual diagram illustrating an example of a process in which a first source driver, a second source driver, and an n-th source driver output data signals.

FIG. 9 is a timing diagram for example signals transmitted and received by a first source driver, a second source driver, and an n-th source driver to and from a timing controller.

FIG. 10 is a conceptual diagram illustrating an example of a process in which a first source driver, a second source driver, and an n-th source driver output readback data.

FIG. 11 is a conceptual diagram illustrating an example of a process in which a first source driver, a second source driver, and an n-th source driver output data signals.

FIG. 12 is a diagram showing example readback data.

FIG. 13 is a diagram showing example readback data according to a comparative example.

FIG. 14 is a drawing showing an example of an eye diagram displayed on a display panel.

FIG. 15 is a drawing showing an example of a normal area and an example of an eye diagram area displayed on a display panel.

FIG. 16 is a flowchart illustrating an example of a process in which a source driver outputs a data signal to a display panel based on the first eye diagram data signal.

FIG. 17 is a flowchart illustrating an example of a process in which a source driver outputs a data signal to a display panel based on eye data.

FIG. 18 is a block diagram of an example of an electronic device.

### DETAILED DESCRIPTION

Below, with reference to the attached drawings, embodiments of the present disclosure is described in detail so that a person having ordinary skill in the art to which the present disclosure pertains may easily practice it. However, the present disclosure may be implemented in many different forms and is not limited to the embodiments described herein. The components in the drawings or detailed description below may be connected to other components other than those depicted in the drawings or described in the detailed description. Additionally, in the flowcharts described with reference to the drawings, the order of operations may be changed, several operations may be merged, some operations may be split, and certain operations may not be performed. The terms used in the text are terms defined in consideration of the functions of the present disclosure and are not limited to specific functions. Definitions of terms may be determined based on the information provided in the detailed description.

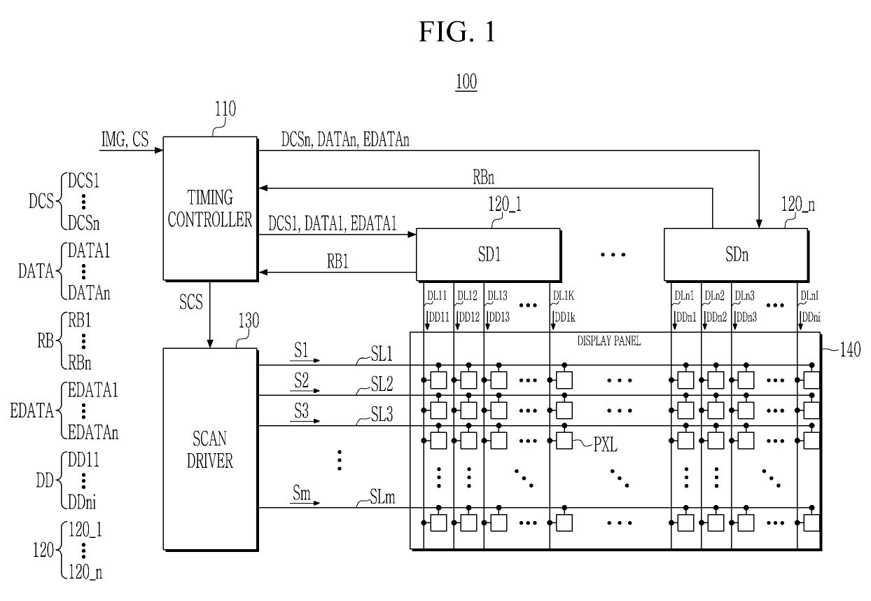

FIG. 1 is a block diagram of an example of a display device according to an embodiment.

Referring to FIG. 1, a display device 100 may include a timing controller 110, a source driver 120, a scan driver 130, and a display panel 140.

The timing controller 110 may receive image data IMG and a driving control signal CS from the host device. The timing controller 110 may control the source driver 120 and the scan driver 130 based on the image data IMG and the driving control signal CS. The host device may be a computing device or system that controls the display device 100 to display an image desired by the user on the display panel 140 from outside. The drive control signal CS provided from the host device may include control commands, setting data, etc. for controlling the source driver 120 and the scan driver 130. The timing controller 110 may generate a source driver control signal DCS that controls the source driver 120 based on the driving control signal CS. The timing controller 110 may generate a scan driver control signal SCS that controls the scan driver 130 based on the drive control signal CS. The timing controller 110 may generate the source driver control signal DCS and the scan driver control signal SCS based on a control command generated by itself, separately from or in addition to the drive control signal CS. The timing controller 110 may generate data DATA in the form of a digital signal based on the image data IMG. The timing controller 110 may output data DATA to the source driver 120.

The source driver 120 may receive the source driver control signal DCS and data DATA in the form of a digital signal from the timing controller 110. The source driver 120 may convert data DATA in the form of a digital signal into an analog signal so that it may be displayed on the display panel 140. Data DATA is information data for displaying the image data IMG on the display panel 140, and may include RGB data, for example. The converted analog signal may be referred to as a data signal. The data signal may be transmitted to the display panel 140 through a plurality of data lines (DL11 to DLnI, where n and I are each integers greater than 1) based on the source driver control signal DCS. The source driver 120 may also be referred to as a data driver.

The source driver 120 may receive data DATA from the timing controller 110. The source driver 120 may receive an eye margin test signal from the timing controller 110. The eye margin test signal may be included in the source driver control signal DCS. The source driver 120 may perform an eye margin test based on the eye margin test signal at an enable level. The source driver 120 may generate eye margin test result data based on the eye margin test signal.

The source driver 120 may output the data signal DD generated based on the eye margin test result data to the display panel 140. A plurality of pixels PXL included in the display panel 140 may receive the data signal DD. The data signal DD generated based on the eye margin test result data may be displayed as an eye diagram on the display panel 140.

The source driver 120 may output the data signal DD generated based on data DATA and the data signal DD generated based on eye margin test result data to the display panel 140 within one frame. A plurality of pixels PXL included in the display panel 140 may receive the data signal DD generated based on the eye margin test result data. During a first period within one frame, the source driver 120 may output the data signal DD generated based on data DATA. The source driver 120 may output the data signal DD generated based on the eye margin test result data to the display panel 140 during a second period within one frame. A plurality of pixels PXL included in the display panel 140 may receive the data signal DD generated based on the eye margin test result data. The first and second periods may be non-overlapping periods within a frame.

In some embodiments, the source driver 120 may output the eye margin test result data as readback data RB to the timing controller 110. The timing controller 110 may generate eye data EDATA based on a readback data RB. The source driver 120 may receive eye data EDATA generated based on readback data RB. The source driver 120 may generate the data signal DD based on eye data EDATA. The source driver 120 may output the data signal DD to the display panel 140. The data signal DD generated based on the eye data EDATA may be displayed as an eye diagram on the display panel 140.

The number of source drivers 120 may be plural. For example, the source driver 120 may include first to n-th source drivers 120_1 to 120_n. The first to n-th source drivers 120_1 to 120_n may each receive different data DATA and source driver control signals DCS. For example, the first source driver 120_1 may receive first data DATA1 and a first source driver control signal DCS1. The n-th source driver 120_n may receive a n-th data DATAn and a n-th source driver control signal DCSn.

The first source driver 120_1 may generate a data signal DD based on the first data DATA1 or eye margin test result data. The first source driver 120_1 may generate the data signal DD based on first data DATA1, which is information data for displaying the image data IMG on the display panel 140. The first source driver 120_1 may output the data signal DD to the display panel 140. At this time, a normal image may be displayed on the plurality of pixels PXL connected to the plurality of data lines DL11 to DL1K. The first source driver 120_1 may generate the data signal DD based on the eye margin test result data. The first source driver 120_1 may output the data signal DD to the display panel 140. At this time, an eye diagram image may be displayed on the plurality of pixels PXL connected to the plurality of data lines DL11 to DL1K. The same applies to the generation of data signals DD for the second to n-th source drivers 120_2 to 120_n.

In some embodiments, at least one of the first to n-th source drivers 120_1 to 120_n may generate the data signal DD based on data DATA during a first period within one frame, and the remaining source drivers may generate the data signal DD based on eye margin test result data during a first period within one frame.

For example, during a first period within a frame, the first source driver 120_1 may generate the data signal DD based on first data DATA1, and an n-th source driver 120_n may generate the data signal DD based on eye margin test result data. Accordingly, during a first period within one frame, a normal image may be displayed on a plurality of pixels PXL connected to a plurality of data lines DL11 to DL1K, and an eye diagram image may be displayed on a plurality of pixels PXL connected to a plurality of data lines DL11 to DL1I.

The first to n-th source drivers 120_1 to 120_n may each be connected to the display panel 140 through a plurality of data lines DL11 to DLnI. For example, the first source driver 120_1 may be connected to the display panel 140 via the 1-1 to 1-k data lines (DL11 to DL1K, where k is an integer greater than 1). The first source driver 120_1 may output a 1-1 data signal DD11 to the 1-1 data line DL11. The first source driver 120_1 may output the 1-2 data signal DD12 to the 1-2 data line DL12. The first source driver 120_1 may output the 1-3 data signal DD13 to the 1-3 data line DL13. The first source driver 120_1 may output a 1-k data signal DD1k to the 1-k data line DL1K.

The n-th source driver 120_n may be connected to the display panel 140 via the n-1 to n-4 data lines DLn1 to DLn4. The n-th source driver 120_n may output the n-1 data signal DDn1 to the n-1 data line DLn1. The n-th source driver 120_n may output the n-2 data signal DDn2 to the n-2 data line DLn2. The n-th source driver 120_n may output the n-3 data signal DDn3 to the n-3 data line DLn3. The n-th source driver 120_n may output the n-i data signal DDni to the n-i data line DLni.

The timing controller 110 may output the scan driver control signal SCS that controls the operation of the scan driver 130 to the scan driver 130. The scan driver 130 may generate a plurality of scan signals S1 to Sm based on the scan driver control signal SCS. The scan driver 130 may output the plurality of scan signals S1 to Sm to each of the plurality of scan lines SL1 to SLm. The scan driver 130 may be connected to the display panel 140 through a plurality of scan lines SL1 to SLm.

The display panel 140 may be connected to the first to n-th source drivers 120_1 to 120_n through a plurality of data lines DL11 to DLnI. The display panel 140 may include a plurality of pixels PXL. The display panel 140 may be connected to the scan driver 130 through a plurality of scan lines SL1 to SLm. Each of the plurality of pixels PXL may be connected to a corresponding one of the plurality of scan lines SL1 to SLm. The display panel 140 may be connected to the source driver 120 through a plurality of data lines DL11 to DLnI. Each of the plurality of pixels PXL may be connected to a corresponding one of the plurality of data lines DL11 to DLnI.

The display device 100 of the present disclosure may display the eye margin test results of data DATA received by the source driver 120 on the display panel 140. Accordingly, the characteristics of the interface circuit of the plurality of source drivers 120_1 to 120_n may be visually confirmed through the eye diagram displayed on the display panel 140.

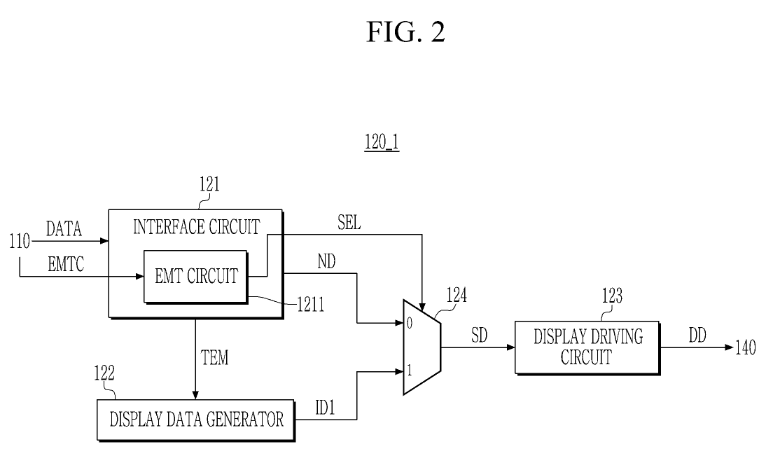

FIG. 2 is a block diagram of an example of a first source driver according to an embodiment.

Referring to FIG. 2, the first source driver 120_1 may include an interface circuit 121, a display data generator 122, a display driving circuit 123, and a multiplexer 124. The first source driver 120_1 may be one of the first to n-th source drivers (120_1 to 120_n in FIG. 1).

The interface circuit 121 may receive data DATA from the timing controller 110. The interface circuit 121 may generate a normal data signal ND by equalizing data DATA, generating a clock signal, and sampling the equalization processing data using the clock signal. The interface circuit 121 may output the normal data signal ND to the multiplexer 124.

The interface circuit 121 may include an EMT circuit 1211. The EMT circuit 1211 may refer to a clock signal as a reference timing for sampling the equalization processing data. The EMT circuit 1211 may receive the eye margin test signal EMTC from the timing controller 110. The EMT circuit 1211 may generate eye margin test result data TEM by sampling data that has been equalized based on the eye margin test signal EMTC at an enable level at a predetermined reference timing interval. The eye margin test result data TEM may include the eye size on the eye diagram of the equalization processing data. The EMT circuit 1211 may output eye margin test result data TEM to the display data generator 122.

The EMT circuit 1211 may control different data signals to be applied based on the plurality of data lines (DL11 to DLnI in FIG. 1). The EMT circuit 1211 may apply a first eye diagram data signal ID1 generated based on the eye margin test result data TEM to a specific data line of a plurality of data lines DL11 to DLnI. The EMT circuit 1211 may generate a selection signal SEL that controls the normal data signal ND to be applied from the data line after a specific data line.

The EMT circuit 1211 may sequentially count the plurality of data lines DL11 to DLnI according to the scanning order of the display panel. The EMT circuit 1211 may determine whether the number of reference lines set as the application range of the eye margin test has been reached. The EMT circuit 1211 may switch the SEL signal from ‘test mode’ to ‘normal mode’ according to the set reference line number. For example, in a section where the SEL signal is set to '1', the test mode is considered and the first eye diagram data signal ID1 based on the eye margin test result data TEM may be applied. In the section where the SEL signal is set to '0', it is considered normal mode and the normal data signal ND for driving a general display may be applied.

The display data generator 122 may generate the first eye diagram data signal ID1 based on the eye margin test result data TEM. The first eye diagram data signal ID1 may include grayscale information for displaying an eye diagram. The display data generator 122 may output the first eye diagram data signal ID1 to the multiplexer 124.

The multiplexer 124 may receive the selection signal SEL from the EMT circuit 1211. The multiplexer 124 may output the first eye diagram data signal ID1 as a selection data signal SD based on the selection signal SEL at an enable level. The multiplexer 124 may output the normal data signal ND as the selection data signal SD based on a disable level selection signal SEL. In some embodiments, the selection signal SEL may transition from an enable level to a disable level or from a disable level to an enable level within a frame. In some embodiments, the selection signal SEL may be maintained at an enable level or a disable level for one frame. The multiplexer 124 may output the selection data signal SD to the display driving circuit 123.

The display driving circuit 123 may generate the data signal DD, which is an analog signal, based on the selection data signal SD, which is digital data, and output the data signal DD to a plurality of data lines.

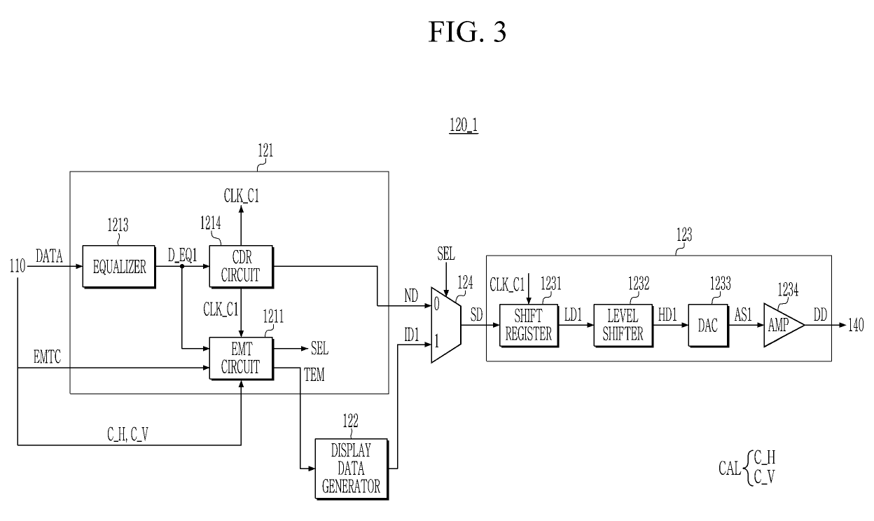

FIG. 3 is a block diagram illustrating an example of a first source driver according to an embodiment.

Referring to FIG. 3, the first source driver 120_1 may include the interface circuit 121, the display data generator 122, the display driving circuit 123, and the multiplexer 124. The first source driver 120_1 may be one of the first to n-th source drivers (120_1 to 120_n in FIG. 1).

The interface circuit 121 may include an equalizer 1213, a CDR circuit 1214, and the EMT circuit 1211.

The equalizer 1213 may receive data DATA from the timing controller 110.

The equalizer 1213 may equalize data DATA and generate a first equalization processing data D_EQ1. The equalizer 1213 may output the first equalization processing data D_EQ1 to the CDR circuit 1214 and the EMT circuit 1211.

The CDR circuit 1214 may generate a first clock signal CLK_C1 based on the first equalization processing data D_EQ1. The CDR circuit 1214 may generate the normal data signal ND by sampling the first equalization processing data D_EQ1 using the first clock signal CLK_C1. The CDR circuit 1214 may output the first clock signal CLK_C1 to the EMT circuit 1211 and the display driving circuit 123. The CDR circuit 1214 may output the normal data signal ND to the multiplexer 124.

The EMT circuit 1211 may receive the eye margin test signal EMTC and calibration data CAL from the timing controller 110 in FIG. 1. Calibration data CAL may include a horizontal correction parameter C_H and a vertical correction parameter C_V. The EMT circuit 1211 may receive the first clock signal CLK_C1 and use it as a reference timing for sampling the first equalization processing data D_EQ1. The EMT circuit 1211 may generate eye margin test result data TEM by sampling the first equalization processing data D_EQ1 at a predetermined reference timing interval according to the eye margin test signal EMTC of the enable level.

The EMT circuit 1211 may move the sampling position of the first equalization processing data D_EQ1 on the time axis based on the first clock signal CLK_C1. The EMT circuit 1211 may control the amount of movement of the sampling position of the first equalization processing data D_EQ1 on the time axis using the horizontal correction parameter C_H. The horizontal correction parameter C_H may be a value indicating how much to move the sampling position of the first equalization processing data D_EQ1 compared to the first clock signal CLK_C1. The EMT circuit 1211 may set a time axis based on the horizontal correction parameter C_H and calculate a horizontal margin of the first equalization processing data D_EQ1. The EMT circuit 1211 may set the voltage axis based on the vertical correction parameter C_V and calculate the vertical margin of the first equalization processing data D_EQ1. The eye size on the eye diagram of the first equalization processing data D_EQ1 may be determined based on the horizontal margin and the vertical margin.

The EMT circuit 1211 may generate eye margin test result data TEM including the eye size on the eye diagram of the first equalization processing data D_EQ1. The EMT circuit 1211 may output eye margin test result data TEM to the display data generator 122.

The display data generator 122 may generate the first eye diagram data signal ID1 based on the eye margin test result data TEM. The first eye diagram data signal ID1 may include grayscale information determined according to the eye size of the first equalization processing data D_EQ1. The display data generator 122 may output the first eye diagram data signal ID1 to the multiplexer 124.

The multiplexer 124 may receive the selection signal SEL from the EMT circuit 1211. The multiplexer 124 may output the first eye diagram data signal ID1 or the normal data signal ND as the selection data signal SD to the display driving circuit 123 based on the level of the selection signal SEL.

The display driving circuit 123 may include a shift register 1231, a level shifter 1232, the digital-to-analog converter 1233, and an amplifier 1234.

The shift register 1231 may receive the first clock signal CLK_C1 from the CDR circuit 1214. The shift register 1231 may serialize the selection data signal SD to generate a first serial data signal LD1. The shift register 1231 may sequentially shift the selection data signal SD in synchronization with the first clock signal CLK_C1. The shift register 1231 may output the first serial data signal LD1 to the level shifter 1232.

The level shifter 1232 may generate a first voltage level conversion data HD1 by converting the voltage level of the first serial data signal LD1 from a low voltage region to a high voltage region. The level shifter 1232 may output the first voltage level conversion data HD1 to the digital-to-analog converter 1233.

The digital-to-analog converter 1233 may convert the first voltage level conversion data HD1 to generate a first analog signal AS1. The digital-to-analog converter 1233 may output a corresponding voltage level as the first analog signal AS1 based on the digital grayscale value included in the first voltage level conversion data HD1. The digital-to-analog converter 1233 may output the first analog signal AS1 to the amplifier 1234.

The amplifier 1234 may amplify the first analog signal AS1 to generate the data signal DD. The amplifier 1234 may generate the data signal DD by increasing the voltage level or driving current of the first analog signal AS1. The amplifier 1234 may output the data signal DD to the display panel 140.

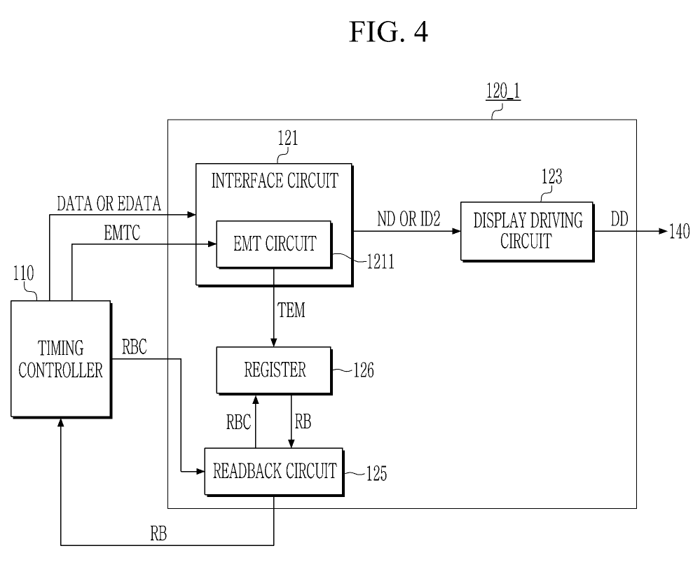

FIG. 4 is a block diagram of an example of a timing controller and an example of a first source driver according to an embodiment.

Referring to FIG. 4, the first source driver 120_1 may include the interface circuit 121, a register 126, a readback circuit 125, and the display driving circuit 123. The first source driver 120_1 may be one of the first to n-th source drivers (120_1 to 120_n in FIG. 1).

The interface circuit 121 may include the EMT circuit 1211. The operation of the interface circuit 121 is the same as described in FIG. 2. The register 126 may receive eye margin test result data TEM from the EMT circuit 1211.

The register 126 may merge the eye margin test result data TEM bit by bit to generate raw readback data. The register 126 may divide the raw readback data according to the standard to generate readback data RB. The register 126 may store readback data RB. The register 126 may output readback data RB to the readback circuit 125.

The readback circuit 125 may receive a readback command signal RBC from the timing controller 110. The readback circuit 125 may perform a readback request by outputting the readback command signal RBC to the register 126. The readback circuit 125 may receive readback data RB from the register 126. The readback circuit 125 may output readback data RB to the timing controller 110 in response to the readback command signal RBC received from the timing controller 110.

The timing controller 110 may generate eye data EDATA based on readback data RB. Eye data EDATA may include grayscale information determined according to the eye size of the first equalization processing data D_EQ1 in FIG. 3. The timing controller 110 may output eye data EDATA to the equalizer 1213.

The interface circuit 121 may receive data DATA or eye data EDATA from the timing controller 110. The interface circuit 121 may generate the normal data signal ND by equalizing data DATA, generating a clock signal, and sampling the equalization processing data using the clock signal. The interface circuit 121 may output the normal data signal ND to the display driving circuit 123. The interface circuit 121 may equalize the eye data EDATA and generate second equalization processing data. The interface circuit 121 may generate a second clock signal based on the second equalization processing data. The interface circuit 121 may generate a second eye diagram data signal ID2 by sampling the second equalization processing data using a second clock signal. The interface circuit 121 may output the second eye diagram data signal ID2 to the display driving circuit 123.

The display driving circuit 123 may generate the data signal DD, which is an analog signal, based on the normal data signal ND or the second eye diagram data signal ID2, and output the data signal DD to a plurality of data lines.

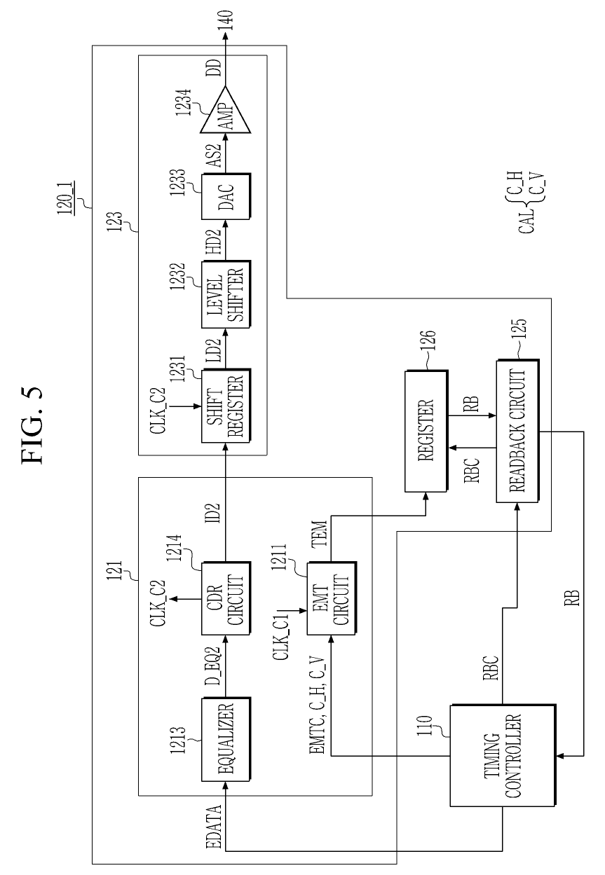

FIG. 5 is a block diagram illustrating an example of a timing controller and an example of a first source driver according to an embodiment.

Referring to FIG. 5, the first source driver 120_1 may include the interface circuit 121, the register 126, the readback circuit 125, and the display driving circuit 123. The first source driver 120_1 may be one of the first to n-th source drivers (120_1 to 120_n in FIG. 1).

The interface circuit 121 may include the equalizer 1213, the CDR circuit 1214, and the EMT circuit 1211. The operation of the interface circuit 121 is the same as described in FIG. 3.

The register 126 may receive eye margin test result data TEM from the EMT circuit 1211. The register 126 may generate readback data RB based on the eye margin test result data TEM. The register 126 may output readback data RB to the readback circuit 125.

The readback circuit 125 may receive the readback command signal RBC from the timing controller 110. The readback circuit 125 may output the readback command signal RBC to the register 126 and receive readback data RB. The readback circuit 125 may output readback data RB to the timing controller 110.

The timing controller 110 may generate eye data EDATA based on readback data RB. Eye data EDATA may include grayscale information determined according to the eye size of the first equalization processing data D_EQ1 in FIG. 3. The timing controller 110 may output eye data EDATA to the equalizer 1213.

The equalizer 1213 may receive eye data EDATA from the timing controller 110. The equalizer 1213 may equalize the eye data EDATA and generate second equalization processing data D_EQ2. The equalizer 1213 may output second equalization processing data D_EQ2 to the CDR circuit 1214.

The CDR circuit 1214 may generate a second clock signal CLK_C2 based on the second equalization processing data D_EQ2. The CDR circuit 1214 may generate the second eye diagram data signal ID2 by sampling the second equalization processing data D_EQ2 using the second clock signal CLK_C2. The CDR circuit 1214 may output the second eye diagram data signal ID2 and the second clock signal CLK_C2 to the display driving circuit 123.

The display driving circuit 123 may include the shift register 1231, the level shifter 1232, a digital-to-analog converter 1233, and the amplifier 1234.

The shift register 1231 may receive the second clock signal CLK_C2 from the CDR circuit 1214. The shift register 1231 may serialize the second eye diagram data signal ID2 to generate a second serial data signal LD2. The shift register 1231 may sequentially shift the second eye diagram data signal ID2 in synchronization with the second clock signal CLK_C2. The shift register 1231 may output the second serial data signal LD2 to the level shifter 1232.

The level shifter 1232 may generate a second voltage level conversion data HD2 by converting the voltage level of the second serial data signal LD2 from a low voltage region to a high voltage region. The level shifter 1232 may output the second voltage level conversion data HD2 to the digital-to-analog converter 1233.

The digital-to-analog converter 1233 may convert the second voltage level conversion data HD2 to generate a second analog signal AS2. The digital-to-analog converter 1233 may output a corresponding voltage level as the second analog signal AS2 based on the digital gradation value included in the second voltage level conversion data HD2. The digital-to-analog converter 1233 may output the second analog signal AS2 to the amplifier 1234.

The amplifier 1234 may amplify the second analog signal AS2 to generate the data signal DD. The amplifier 1234 may generate the data signal DD by increasing the voltage level or driving current of the second analog signal AS2. The amplifier 1234 may output the data signal DD to the display panel 140.

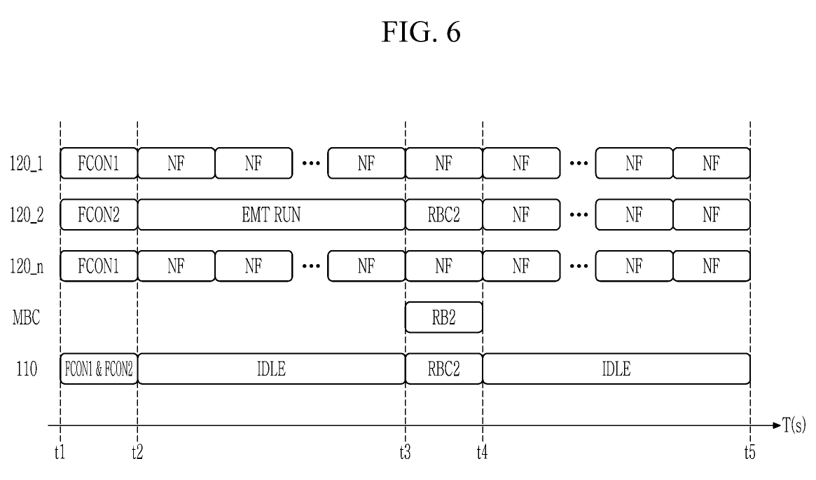

FIG. 6 is a timing diagram for example signals transmitted and received by a first source driver, a second source driver, and an n-th source driver to and from a timing controller according to an embodiment.

Referring to FIG. 6, in the period t1 to t2, the timing controller 110 may generate a first frame setting command FCON1 and a second frame setting command FCON2. The first frame setting command FCON1 may include basic setup information for frame display. Basic setup information for frame display may include frame position and resolution information. Frame position information may indicate the horizontal and vertical start and end positions of a frame. Resolution information may refer to the number of pixels PXL in FIG. 1 included in the effective display area of the display panel 140 in FIG. 1. The second frame setting command FCON2 may include the eye margin test signal and calibration data.

In the t1~t2 section, the timing controller 110 may output the first frame setting command FCON1 to the first source driver 120_1 and the n-th source driver 120_n. The timing controller 110 may output the second frame setting command FCON2 to the second source driver 120_2.

In the t2~t3 section, the first source driver 120_1 and the n-th source driver 120_n may generate a data signal based on a normal data signal. The first source driver 120_1 and the n-th source driver 120_n may output data signals to the plurality of data lines.

In the t2~t3 section, the second source driver 120_2 may generate eye margin test result data by sampling data equalized according to the eye margin test signal at an enable level at a predetermined reference timing interval. The second source driver 120_2 may generate a second readback data RB2 based on the eye margin test result data.

In the t3~t4 section, the timing controller 110 may generate a second readback command signal RBC2. The timing controller 110 may output the second readback command signal RBC2 to the second source driver 120_2. The second source driver 120_2 may output second readback data RB2 to a monitoring back channel MBC in response to the second readback command signal RBC2. The timing controller 110 may receive second readback data RB2 from the monitoring back channel MBC. The timing controller 110 may generate a second eye data based on the second readback data RB2. The first source driver 120_1 and the n-th source driver 120_n may generate a data signal based on a normal data signal. The first source driver 120_1 and the n-th source driver 120_n may output data signals to the plurality of data lines.

In the t4~t5 section, the second source driver 120_2 may generate a data signal based on the second eye data. The second source driver 120_2 may output data signals to the plurality of data lines. The first source driver 120_1 and the n-th source driver 120_n may generate a data signal based on a normal data signal. The first source driver 120_1 and the n-th source driver 120_n may output data signals to the plurality of data lines.

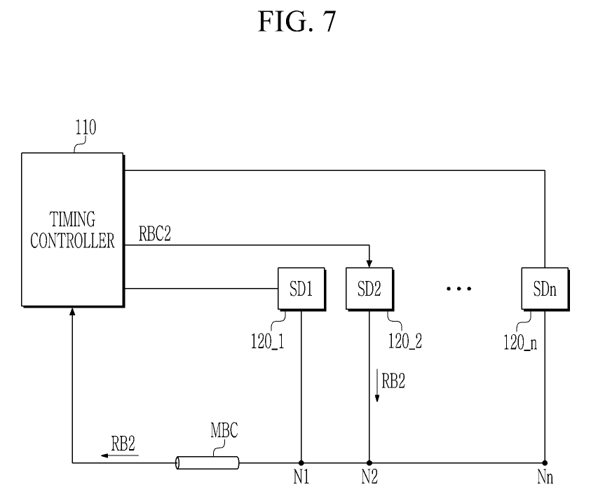

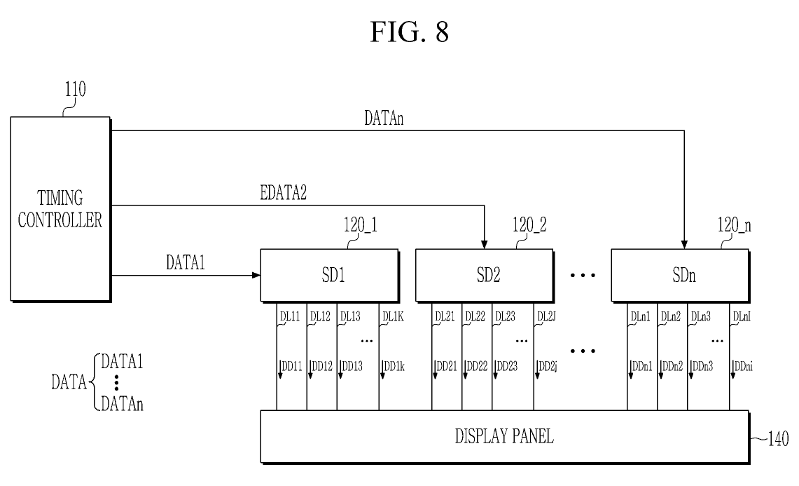

FIG. 7 is a conceptual diagram illustrating an example of a process in which a second source driver outputs readback data according to an embodiment. FIG. 8 is a conceptual diagram illustrating an example of a process in which the plurality of source drivers output data signals according to an embodiment.

Referring to FIG. 7, the second source driver SD2 may receive the second readback command signal RBC2 from the timing controller 110. The second source driver SD2 may output second readback data RB2 to a second node N2 in response to the second readback command signal RBC2. The timing controller 110 may receive second readback data RB2 from the second node N2 through the monitoring back channel MBC.

Referring to FIG. 8, the first source driver 120_1 may receive first data DATA1 from the timing controller 110. The second source driver 120_2 may receive the second eye data EDATA2 from the timing controller 110. The n-th source driver 120_n may receive the n-th data DATAn from the timing controller 110.

The first source driver 120_1 may equalize the first data DATA1 and generate equalization processing data. The first source driver 120_1 may generate a normal data signal based on the equalization processing data. The first source driver 120_1 may generate the 1-1th to 1-kth data signals DD11 to DD1k based on the normal data signal. The first source driver 120_1 may output the 1-1th to 1-kth data signals DD11 to DD1k to each of a plurality of data lines DL11 to DL1K. The display panel 140 may receive the 1-1th to 1-kth data signals DD11 to DD1k through a plurality of data lines DL11 to DL1K.

The second source driver 120_2 may equalize the second eye data EDATA2 and generate equalization processing data. The second source driver 120_2 may generate a second eye diagram data signal based on the equalization processing data. The second source driver 120_2 may generate the 2-1th to 2-jth data signals DD21 to DD2j based on the second eye diagram data signal. The second source driver 120_2 may output the 2-1th to 2-jth data signals DD21 to DD2j to each of the plurality of data lines DL21 to DL2J. The display panel 140 may receive the 2-1th to 2-jth data signals DD21 to DD2j through a plurality of data lines DL21 to DL2J.

The n-th source driver 120_n may equalize the n-th data DATAn and generate equalization processing data. The n-th source driver 120_n may generate a normal data signal based on the equalization processing data. The n-th source driver 120_n may generate the n-1 to n-i data signals DDn1 to DDni based on the normal data signal. The n-th source driver 120_n may output n-1 to n-i data signals DDn1 to DDni to each of a plurality of data lines DLn1 to DLnI. The display panel 140 may receive n-1 to n-i data signals DDn1 to DDni through a plurality of data lines DLn1 to DLnI.

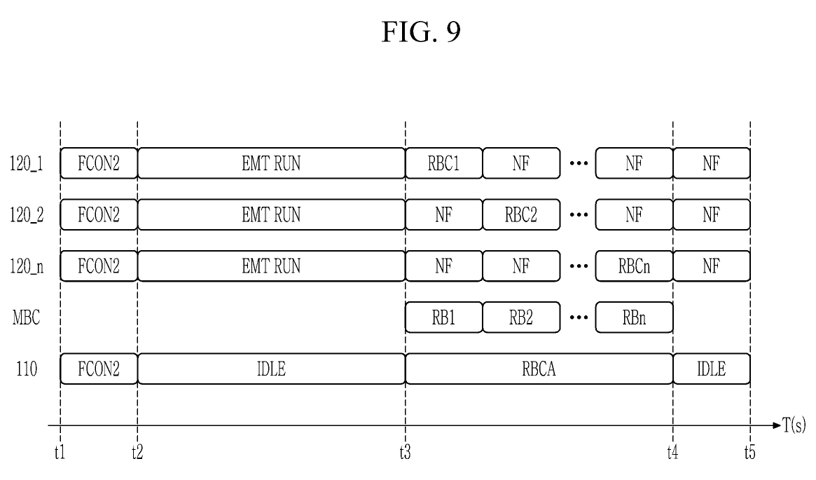

FIG. 9 is a timing diagram for example signals transmitted and received by a first source driver, a second source driver, and an n-th source driver to and from a timing controller according to an embodiment.

Referring to FIG. 9, in the period t1 to t2, the timing controller 110 may generate the second frame setting command FCON2. The second frame setting command FCON2 may include the eye margin test signal and calibration data.

In the t2~t3 section, the first source driver 120_1, the second source driver 120_2, and the n-th source driver 120_n may generate eye margin test result data by sampling data equalized according to the eye margin test signal at an enable level at a predetermined reference timing interval. The first source driver 120_1 may generate a first readback data RB1 based on the eye margin test result data. The second source driver 120_2 may generate second readback data RB2 based on the eye margin test result data. The n-th source driver 120_n may generate a n-th readback data RBn based on the eye margin test result data.

In the t3~t4 period, the timing controller 110 may generate an integrated readback command signal RBCA. The integrated readback command signal RBCA may include a first readback command signal RBC1, the second readback command signal RBC2, and an n-th readback command signal RBCn. The timing controller 110 may output the first readback command signal RBC1 to the first source driver 120_1. The timing controller 110 may output the second readback command signal RBC2 to the second source driver 120_2. The timing controller 110 may output the n-th readback command signal RBCn to the n-th source driver 120_n.

The first source driver 120_1 may output the first readback data RB1 to the monitoring back channel MBC in response to the first readback command signal RBC1. The second source driver 120_2 may output second readback data RB2 to the monitoring back channel MBC in response to the second readback command signal RBC2. The n-th source driver 120_n may output the n-th readback data RBn to the monitoring back channel MBC in response to the n-th readback command signal RBCn.

The timing controller 110 may sequentially receive first readback data RB1, second readback data RB2, and the n-th readback data RBn from the monitoring back channel MBC. The timing controller 110 may generate a first eye data to the n-th eye data based on the first readback data RB1, the second readback data RB2, and the n-th readback data RBn.

In the t4~t5 section, the first source driver 120_1 may generate a data signal based on the first eye data. The first source driver 120_1 may output data signals to the plurality of data lines. The second source driver 120_2 may generate a data signal based on the second eye data. The second source driver 120_2 may output data signals to the plurality of data lines. The n-th source driver 120_n may generate a data signal based on the n-th eye data. The n-th source driver 120_n may output data signals to the plurality of data lines.

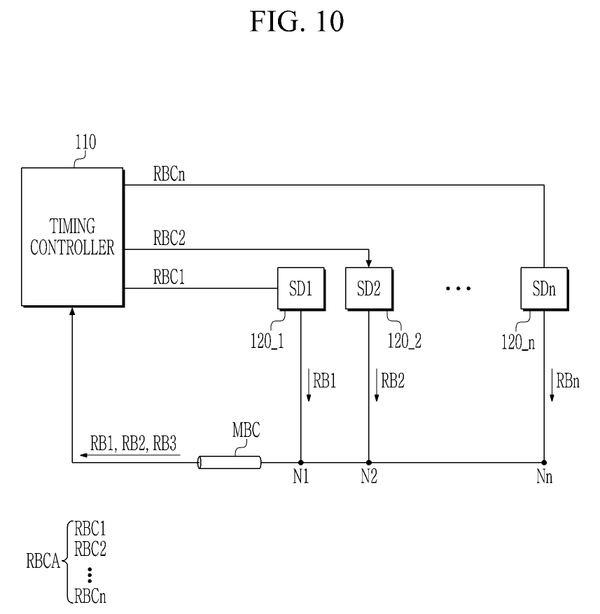

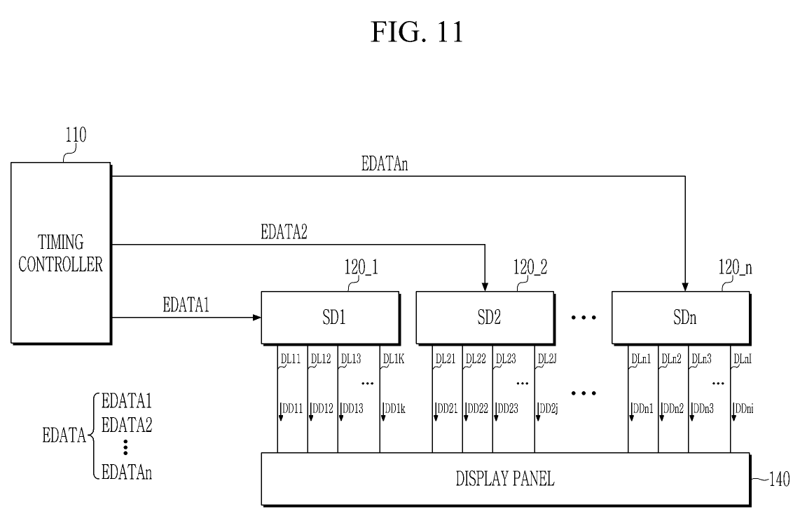

FIG. 10 is a conceptual diagram illustrating an example of a process in which a first source driver, a second source driver, and an n-th source driver output readback data according to an embodiment. FIG. 11 is a conceptual diagram illustrating an example of a process in which the plurality of source drivers output data signals according to an embodiment.

Referring to FIG. 10, the timing controller 110 may generate the integrated readback command signal RBCA. The first source driver SD1 may receive the first readback command signal RBC1 from the timing controller 110. The second source driver SD2 may receive the second readback command signal RBC2 from the timing controller 110. The n-th source driver SDn may receive the n-th readback command signal RBCn from the timing controller 110.

The first source driver SD1 may output first readback data RB1 to a first node N1 in response to the first readback command signal RBC1. The second source driver SD2 may output second readback data RB2 to the second node N2 in response to the second readback command signal RBC2. The n-th source driver SDn may output the n-th readback data RBn to the n-th node Nn in response to the n-th readback command signal RBCn.

The timing controller 110 may sequentially receive the first readback data RB1, the second readback data RB2, and the n-th readback data RBn through the monitoring back channel MBC.

Referring to FIG. 11, the plurality of source drivers (120_1, 120_2, and 120_n) may each receive eye data EDATA from the timing controller 110. For example, the first source driver 120_1 may receive the first eye data EDATA 1 from the timing controller 110. The second source driver 120_2 may receive the second eye data EDATA2 from the timing controller 110. The n-th source driver 120_n may receive the n-th eye data EDATAn from the timing controller 110.

The first source driver 120_1 may equalize the first eye data EDATA1 and generate equalization processing data. The first source driver 120_1 may generate a second eye diagram data signal based on the equalization processing data. The first source driver 120_1 may generate the 1-1th to 1-kth data signals DD11 to DD1k based on the second eye diagram data signal. The first source driver 120_1 may output the 1-1th to 1-kth data signals DD11 to DD1k to each of a plurality of data lines DL11 to DL1K. The display panel 140 may receive the 1-1th to 1-kth data signals DD11 to DD1k through a plurality of data lines DL11 to DL1K.

The second source driver 120_2 may equalize the second eye data EDATA2 and generate equalization processing data. The second source driver 120_2 may generate a second eye diagram data signal based on the equalization processing data. The second source driver 120_2 may generate the 2-1th to 2-jth data signals DD21 to DD2j based on the second eye diagram data signal. The second source driver 120_2 may output the 2-1th to 2-jth data signals DD21 to DD2j to each of the plurality of data lines DL21 to DL2J. The display panel 140 may receive the 2-1th to 2-jth data signals DD21 to DD2j through a plurality of data lines DL21 to DL2J.

The n-th source driver 120_n may equalize the n-th eye data EDATAn and generate equalization processing data. The n-th source driver 120_n may generate a second eye diagram data signal based on the equalization processing data. The n-th source driver 120_n may generate the n-1 to n-i data signals DDn1 to DDni based on the second eye diagram data signal. The n-th source driver 120_n may output n-1 to n-i data signals DDn1 to DDni to each of a plurality of data lines DLn1 to DLnI. The display panel 140 may receive n-1 to n-i data signals DDn1 to DDni through a plurality of data lines DLn1 to DLnI.

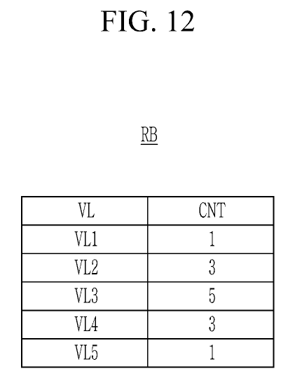

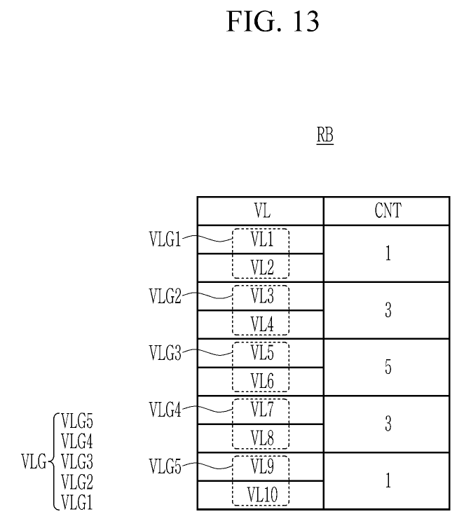

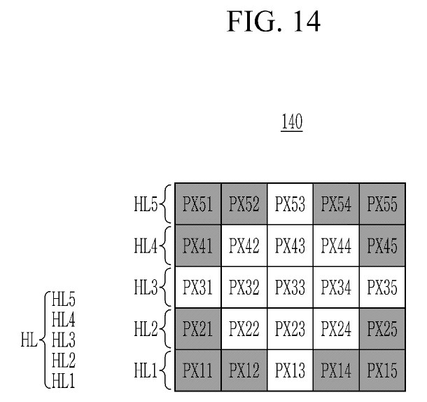

FIG. 12 is a diagram showing example readback data according to an embodiment. FIG. 13 is a diagram showing example readback data according to a comparative example. FIG. 14 is a drawing showing an example of an eye diagram displayed on a display panel according to an embodiment.

Referring to FIGS. 12 and 14, the readback data RB may represent a vertical level VL and an eye diagram counting value CNT corresponding to the vertical level VL. The vertical level VL may correspond to a vertical length HL of the display panel 140. The eye diagram counting value CNT may mean the number of pixels displaying the eye diagram among a plurality of pixels corresponding to the vertical length HL of the display panel 140. The explanation will continue assuming that the display panel 140 has a 5×5 resolution.

At a first vertical level VL1, the eye diagram counting value CNT may be 1. At a second vertical level VL2, the eye diagram counting value CNT may be 3. At a third vertical level VL3, the eye diagram counting value CNT may be 5. At a fourth vertical level VL4, the eye diagram counting value CNT may be 3. At a fifth vertical level VL5, the eye diagram counting value CNT may be 1.

Referring to FIGS. 13 and 14, the readback data RB may represent the vertical level VL and the eye diagram counting value CNT corresponding to the vertical level VL. A vertical level group VLG may group the plurality of adjacent vertical levels VLs. For example, a first vertical level group VLG1 may group the first vertical level VL1 and the second vertical level VL2. A second vertical level group VLG2 may group the third vertical level VL3 and the fourth vertical level VL4. A third vertical level group VLG3 may group the fifth vertical level VL5 and a sixth vertical level VL6. The fourth vertical level group VLG4 may group a seventh vertical level VL7 and an eighth vertical level VL8. The fifth vertical level group VLG5 may group a ninth vertical level VL9 and a tenth vertical level VL10. The vertical level group VLG may correspond to the vertical length HL of the display panel 140.

The eye diagram counting value CNT of each vertical level group VLG may be an average value of the eye diagram counting values corresponding to the vertical levels VLs included in each vertical level group VLG. For example, in the first vertical level group VLG1, the eye diagram counting value CNT may be 1. In the second vertical level group VLG2, the eye diagram counting value CNT may be 3. In the third vertical level group VLG3, the eye diagram counting value CNT may be 5. In the fourth vertical level group VLG4, the eye diagram counting value CNT may be 3. In the fifth vertical level group VLG5, the eye diagram counting value CNT may be 1.

The 1-3 pixel PX13 in a first vertical length HL1 of the display panel 140 may have a first luminance based on high-gray information. In the first vertical length HL1 of the display panel 140, the 1-1 pixel PX11, the 1-2 pixel PX12, the 1-4 pixel PX14, and the 1-5 pixel PX15 may have a second luminance lower than the first luminance based on low-gray information.

In a second vertical length HL2 of the display panel 140, the 2-2 pixel PX22, the 2-3 pixel PX23, and the 2-4 pixel PX24 may have a first luminance based on high-gray information. In the second vertical length HL2 of the display panel 140, the 2-1 pixel PX21 and the 2-5 pixel PX25 may have a second luminance lower than the first luminance based on low-gray information.

In a third vertical length HL3 of the display panel 140, the 3-1 pixel PX31, the 3- 2 pixel PX32, the 3-3 pixel PX33, the 3-4 pixel PX34, and the 3-5 pixel PX35 may have a first luminance based on high-gray information.

In a fourth vertical length HL4 of the display panel 140, the 4-2 pixel PX42, the 4-3 pixel PX43, and the 4-4 pixel PX44 may have a first luminance based on high-gray information. In the fourth vertical length HL4 of the display panel 140, the 4-1 pixel PX41 and the 4-5 pixel PX45 may have a second luminance lower than the first luminance based on low-gray information.

The 5-3 pixel PX53 in the 5th vertical length HL5 of the display panel 140 may have a first luminance based on high-gray information. In a fifth vertical length HL5 of the display panel 140, the 5-1 pixel PX51, the 5-2 pixel PX52, the 5-4 pixel PX54, and the 5-5 pixel PX55 may have a second luminance lower than the first luminance based on low-gray information.

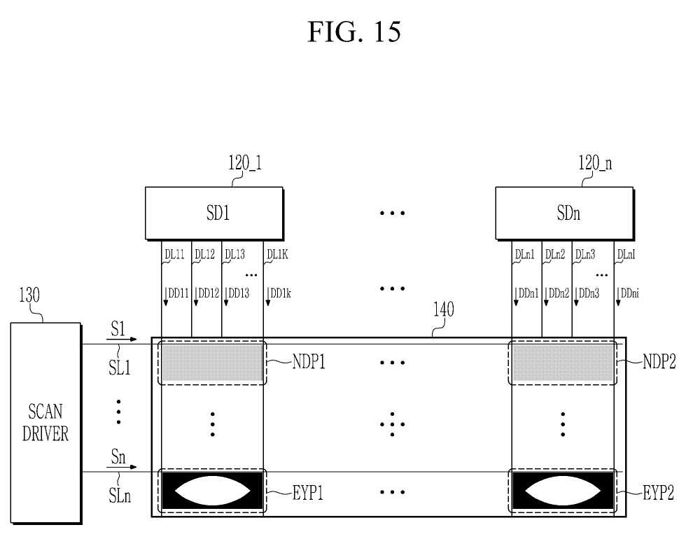

FIG. 15 is a drawing showing an example of a normal area and an example of an eye diagram area displayed on a display panel according to an embodiment.

Referring to FIG. 15, the display panel 140 may receive the 1-1 data signal DD11 to the 1-k data signal DD1k from the first source driver 120_1. The display panel 140 may receive the n-1 data signal DDn1 to the n-i data signal DDni from the n-th source driver 120_n. The display panel 140 may sequentially receive the plurality of scan signals S1 to Sn from the scan driver 130.

When the first scan signal S1 is applied to the display panel 140 through the first scan line SL1, the 1-1 data signal DD11 to the 1-k data signal DD1k corresponding to the normal data signal ND of FIG. 2 from the first source driver 120_1 may be applied to a plurality of pixels connected to the first scan line SL1. From the n-th source driver 120_n, the n-1 data signal DDn1 to the n-i data signal DDni corresponding to the normal data signal ND may be applied to a plurality of pixels connected to the first scan line SL1. Accordingly, the display panel 140 may display a first normal area NDP1 and a second normal area NDP2.

When the n-th scan signal Sn is applied to the display panel 140 through the n-th scan line SLn, the 1-1 data signal DD11 to the 1-k data signal DD1k corresponding to the first eye diagram data signal ID1 of FIG. 2 or eye data EDATA of FIG. 4 from the first source driver 120_1 may be applied to a plurality of pixels connected to the n-th scan line SLn. From the n-th source driver 120_n, the n-1 data signal DDn1 to the n-i data signal DDni corresponding to the first eye diagram data signal ID1 or eye data EDATA may be applied to a plurality of pixels connected to the n-th scan line SLn. Accordingly, the display panel 140 may display a first eye diagram area EYP1 and a second eye diagram area EYP2.

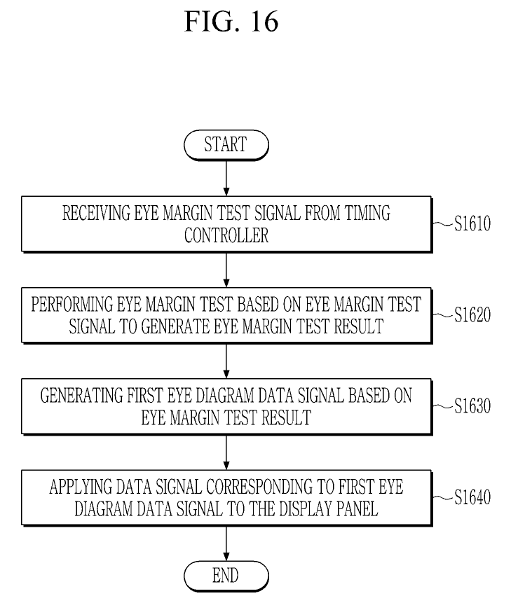

FIG. 16 is a flowchart illustrating an example of a process in which a source driver outputs a data signal to a display panel based on the first eye diagram data signal according to an embodiment.

Referring to FIG. 16, at step S1610, the source driver may receive the eye margin test signal from the timing controller. The source driver may receive calibration data from the timing controller. Calibration data may include horizontal calibration parameters and vertical calibration parameters.

The source driver may receive data from the timing controller. The source driver may equalize data received from the timing controller and generate equalization processing data. The source driver may generate a first clock signal based on the equalization processing data.

In step S1620, the source driver may perform an eye margin test based on the eye margin test signal and generate an eye margin test result. The source driver may sample equalization processing data based on the first clock signal. The source driver may generate eye margin test result data by sampling equalization processing data at a predetermined reference timing interval according to the eye margin test signal at an enable level.

The source driver may move the sampling position of the equalization processing data on the time axis based on the first clock signal. The source driver may control the amount of movement along the time axis of the sampling position of the equalization processing data using the horizontal correction parameter. The horizontal correction parameter may be a value indicating how much to shift the sampling position of the equalization processing data compared to the first clock signal.

The source driver may set the time axis based on the horizontal correction parameters and calculate the horizontal margin of the equalization processing data. The source driver may set the voltage axis based on the vertical compensation parameters and calculate the vertical margin of the equalization processing data. The eye size on the eye diagram of the equalization processing data may be determined based on the horizontal margin and vertical margin. The source driver may generate eye margin test result data including the eye size on the eye diagram of the equalization processing data.

In step S1630, the source driver may generate the first eye diagram data signal based on the eye margin test result. The source driver may generate the first eye diagram data signal based on eye margin test result data TEM. The first eye diagram data signal may include grayscale information determined according to the eye size of the equalization processing data.

In step S1640, the source driver may apply a data signal corresponding to the first eye diagram data signal to the display panel. The source driver may output the first eye diagram data signal as the selection data signal based on a selection signal at an enable level. The source driver may serialize the selection data signal to generate a first serial data signal. The source driver may generate the first voltage level conversion data by converting the voltage level of the first serial data signal from a low voltage region to a high voltage region. The source driver may convert the first voltage level conversion data to generate a first analog signal. The source driver may amplify the first analog signal to generate a data signal. The source driver may output data signals to the display panel.

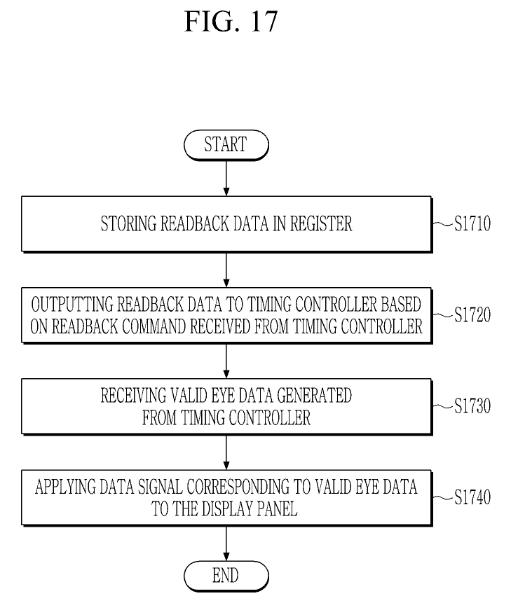

FIG. 17 is a flowchart illustrating an example of a process in which a source driver outputs a data signal to a display panel based on eye data according to an embodiment.

Referring to FIG. 17, in step S1710, the source driver may store readback data in a register. The register may merge the eye margin test result data bit by bit to generate raw readback data. Readback data may be generated by splitting raw readback data into a specification.

In step S1720, the source driver may output readback data to the timing controller based on the readback command signal.

At step S1730, the source driver may receive eye data generated from the timing controller. Eye data may be generated based on readback data. Eye data may include grayscale information determined according to the eye size of the equalization processing data.

In step S1740, the source driver may output a data signal corresponding to the eye data to the display panel. The source driver may equalize the eye data and generate secondary equalization processing data. The source driver may generate a second clock signal based on the second equalization processing data. The source driver may generate a second eye diagram data signal by sampling the second equalization processing data using a second clock signal. The source driver may serialize the second eye diagram data signal to generate a second serial data signal. The source driver may generate the second voltage level conversion data by converting the voltage level of the second serial data signal from a low voltage region to a high voltage region. The source driver may convert the second voltage level conversion data to generate a second analog signal. The source driver may amplify the second analog signal to generate a data signal. The source driver may output data signals to the display panel.

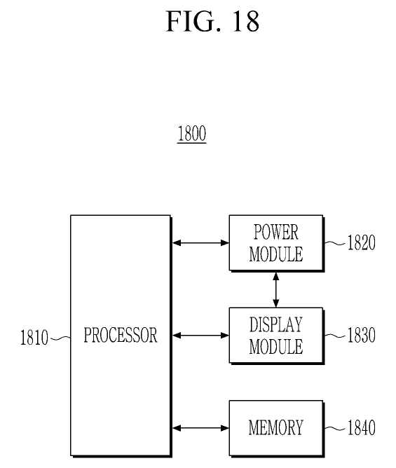

FIG. 18 is a block diagram of an example of an electronic device according to an embodiment.

Referring to FIG. 18, an electronic device 1800 may include a processor 1810, a power module 1820, a display module 1830, and a memory 1840.

The processor 1810 may include at least one of a central processing unit CPU, an application processor AP, a graphic processing unit GPU, a communication processor CP, an image signal processor ISP, and a controller.

The memory 1840 may store data information necessary for the operation of the processor 1810 or the display module 1830. When the processor 1810 executes an application stored in the memory 1840, image data signal and/or an input control signal is transmitted to the display module 1830, and the display module 1830 may process the received signal and output image information through a display screen.

The power module 1820 may include a power supply module, such as a power adapter or a battery device, and a power conversion module that converts power supplied by the power supply module to generate power required for the operation of the electronic device 1800. The power module 1820 may supply power to the display module and processor.

The display module 1830 may receive data from the processor 1810. The display module 1830 may equalize data and generate equalization processing data. The display module 1830 may generate a first clock signal based on the equalization processing data. The display module 1830 may generate a normal data signal by sampling data that has been equalized using a first clock signal. The display module 1830 may receive the eye margin test signal from the processor 1810. The display module 1830 may generate eye margin test result data based on the eye margin test signal at an enable level. The display module 1830 may receive a test signal from the processor 1810. The display module 1830 may generate the first eye diagram data signal based on the eye margin test result data. The display module 1830 may output a data signal corresponding to the first eye diagram data signal to the display panel.

The display module 1830 may output readback data containing eye margin test result data to the processor 1810. The processor 1810 may generate eye data based on the readback data. The display module 1830 may output a data signal corresponding to the eye data to the display panel.

At least one of the components of the electronic device 1800 may be included in the display device according to the described embodiments. Additionally, some of the individual modules functionally included within a module may be included within the display device, while others may be provided separately from the display device. For example, the display device may include the display module 1830, and the processor 1810, memory 1840, and power module 1820 may be provided in the form of other devices within the electronic device 1800 other than the display device.

While this specification contains many specific embodiment details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be excised from the combination, and the combination may be directed to a subcombination or variation of a subcombination.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. A display device comprising:
a display panel including a plurality of pixels and a plurality of data lines connected to the plurality of pixels;
a timing controller configured to
receive image data, and
output data generated based on the image data and an eye margin test signal, wherein the eye margin test signal is configured to instruct testing of an eye margin; and
a source driver connected to corresponding data lines among the plurality of data lines, wherein the source driver is configured to
receive first data among the data output from the timing controller and the eye margin test signal, wherein the first data corresponds to pixels connected to the data lines,
perform the eye margin test on the first data to generate an eye margin test result data,
generate a plurality of data signals corresponding to the eye margin test result data, and
output the plurality of data signals to the data lines.

2. The display device of claim 1, wherein the source driver is configured to:
generate a plurality of eye diagram data signals corresponding to the data lines based on the eye margin test result data, wherein the plurality of eye diagram data signals include grayscale information for displaying an eye diagram; and
generate the plurality of data signals based on the plurality of eye diagram data signals.

3. The display device of claim 2, wherein the source driver comprises:
an interface circuit configured to
generate an equalization processing data by equalizing the first data,
generate a plurality of normal data signals corresponding to the data lines based on the equalization processing data, and
generate the eye margin test result data by sampling the equalization processing data at a reference timing interval based on the eye margin test signal at an enable level;
a display data generator configured to generate the plurality of eye diagram data signals including the grayscale information for displaying the eye diagram based on the eye margin test result data;
a multiplexer configured to
receive a selection signal,
output the plurality of eye diagram data signals as data selection signals based on the selection signal at the enable level, and
output the plurality of normal data signals as the data selection signals based on the selection signal at a disable level; and
a display driving circuit configured to
generate the plurality of data signals, which are analog signals, based on the data selection signals, and
output the plurality of data signals to the data lines.

4. The display device of claim 3, wherein the interface circuit comprises:
an equalizer configured to equalize the first data to generate the equalization processing data;
a Clock Data Recovery (CDR) circuit configured to
generate a clock signal based on the equalization processing data, and
generate the plurality of normal data signals by sampling the equalization processing data using the clock signal; and
an Eye Margin Test (EMT) circuit configured to
receive calibration data from the timing controller, and
generate the eye margin test result data by sampling the equalization processing data using the calibration data.

5. The display device of claim 4, wherein:
the calibration data includes horizontal correction parameters and vertical correction parameters; and
the EMT circuit is configured to
move sampling position of the equalization processing data on a time axis based on the horizontal correction parameter,
calculate a horizontal margin of the equalization processing data,
set a voltage axis of the equalization processing data based on the vertical correction parameter, and
calculate a vertical margin of the equalization processing data.

6. The display device of claim 3, wherein the display driving circuit comprises:
a shift register configured to serialize the data selection signals to generate a serial data signal;
a level shifter configured to generate voltage level conversion data by converting a voltage level of the serial data signal from a low voltage region to a high voltage region;
a digital-to-analog converter configured to
convert the voltage level conversion data to generate an analog signal based on a digital gradation value included in the voltage level conversion data, and
output the analog signal; and
an amplifier configured to amplify a voltage level of the analog signal to generate the plurality of data signals.

7. The display device of claim 3, wherein:
the source driver is configured to output the plurality of data signals generated based on the plurality of normal data signals during a first period, in which the selection signal is at a disable level, within a first frame, to the data lines; and
the source driver is configured to output the plurality of data signals generated based on the plurality of eye diagram data signals to the data lines during a second period, in which the selection signal is at an enable level, within the first frame.

8. The display device of claim 3, wherein:
the display device comprises a plurality of source drivers, each source driver of the plurality of source drivers is connected to corresponding data lines among the plurality of data lines;
a first portion of the plurality of source drivers are configured to output the plurality of data signals generated based on the plurality of normal data signals during a first period of a first frame to the data lines corresponding to the first portion of the plurality of source drivers; and
a remaining portion of the plurality of source drivers is configured to output the plurality of data signals generated based on the plurality of eye diagram data signals during the first period of the first frame to the data lines corresponding to the remaining portion of the plurality of source drivers.

9. The display device of claim 1, wherein:
the timing controller is configured to
generate eye data based on the eye margin test result data, and
output the eye data to the source driver, and
the source driver is configured to
generate a plurality of eye diagram data signals corresponding to the data lines based on the eye data, wherein the plurality of eye diagram data signals include grayscale information for displaying an eye diagram, and
generate a plurality of data signals based on the plurality of eye diagram data signals.

10. The display device of claim 9, wherein the source driver comprises:
an interface circuit configured to
generate first equalization processing data by equalizing the first data, and
generate the eye margin test result data by sampling the first equalization processing data at a reference timing interval based on the eye margin test signal at an enable level;
a register configured to
generate raw readback data by merging the eye margin test result data bit by bit, and
generate readback data including the grayscale information for displaying the eye diagram by dividing the raw readback data;
a readback circuit configured to
receive a readback command signal from the timing controller, and
transmit the readback data received from the register to the timing controller in response to the readback command signal; and
a display driving circuit configured to
generate the plurality of data signals, which are analog signals, based on the readback data, and
output the plurality of data signals to the data lines.

11. The display device of claim 10, wherein the interface circuit comprises:
an equalizer configured to equalize the first data to generate the first equalization processing data;
a Clock Data Recovery (CDR) circuit configured to
generate a first clock signal based on the first equalization processing data, and
generate a plurality of normal data signals corresponding to the data lines by sampling the first equalization processing data using the first clock signal; and
an EMT circuit configured to
receive calibration data from the timing controller, and
generate the eye margin test result data by sampling the first equalization processing data at a reference timing interval using the calibration data.

12. The display device of claim 11, wherein:
the timing controller is configured to
generate the readback command signal, wherein the readback command signal is a signal configured to instruct retrieval of the readback data stored in the register, and
transmit the readback command signal to the readback circuit; and
the readback circuit is configured to
output the readback command signal to the register,
receive the readback data from the register, and
transmit the readback data to the timing controller.

13. The display device of claim 12, wherein:
the readback data includes a plurality of vertical levels and a first eye diagram counting value corresponding to the plurality of vertical levels, the plurality of vertical levels correspond to vertical length values of the display panel, the first eye diagram counting value corresponds to a number of pixels displaying the eye diagram among the plurality of pixels corresponding to the vertical length values of the display panel.

14. The display device of claim 13, wherein:
the readback data includes a plurality of vertical level groups, in which at least one vertical level among the plurality of vertical levels is grouped, and a second eye diagram counting value of each vertical level group of the plurality of vertical level groups is an average value of a plurality of first eye diagram counting values corresponding to a plurality of vertical levels included in the vertical level group.

15. The display device of claim 10, wherein:
the timing controller is configured to
generate the eye data based on the readback data, and
output the eye data to the interface circuit; and
the interface circuit is configured to
generate second equalization processing data by equalizing the eye data,
generate a second clock signal based on the second equalization processing data, and
generate the plurality of eye diagram data signals by sampling the second equalization processing data using the second clock signal.

16. A source driver comprising:
an interface circuit configured to
generate equalization processing data by equalizing data,
generate a normal data signal based on the equalization processing data, and
generate eye margin test result data by sampling the equalization processing data at a reference timing interval based on an eye margin test signal at an enable level; and
a display driving circuit configured to generate a data signal corresponding to the eye margin test result data.

17. The source driver of claim 16, wherein the interface circuit comprises:
a display data generator configured to generate an eye diagram data signal, including grayscale information for displaying an eye diagram, based on the eye margin test result data; and
a multiplexer configured to output the eye diagram data signal based on a selection signal at the enable level.

18. The source driver of claim 17, wherein the display driving circuit comprises:
a shift register configured to serialize the eye diagram data signal to generate a serial data signal;
a level shifter configured to generate voltage level conversion data by converting a voltage level of the serial data signal from a low voltage region to a high voltage region;
a digital-to-analog converter configured to output an analog signal based on a digital gradation value included in the voltage level conversion data; and
an amplifier configured to amplify a voltage level of the analog signal to generate the data signal.

19. The source driver of claim 17, wherein the source driver comprises:
a register configured to
merge the eye margin test result data in bit units to generate raw readback data, and
divide the raw readback data to generate readback data containing grayscale information for displaying an eye diagram; and
a readback circuit configured to
receive a readback command signal from a timing controller, and
transmit readback data received from the register to the timing controller in response to the readback command signal, wherein:
the timing controller is configured to
generate eye data based on the readback data, and
output the eye data to the interface circuit,
the interface circuit is configured to generate the eye diagram data signal including the grayscale information for displaying the eye diagram based on the eye data, and
the display driving circuit is configured to generate the data signal based on the eye diagram data signal.

20. A method of driving a display device comprising:
receiving an eye margin test signal from a timing controller, the eye margin test signal instructing a test of data and eye margin;
performing an eye margin test on the data to generate eye margin test result data;
generating an eye diagram data signal including grayscale information for displaying an eye diagram based on the eye margin test result data; and
applying a data signal corresponding to the eye diagram data signal to a plurality of pixels.
